(19) United States
(12) Patent Application Publication
(10) Pub. No.: US 2025/0158840 A1
(43) Pub. Date: May 15, 2025

(54) DECENTRALIZED MISSION PLANNING, COMMAND, AND CONTROL

(71) Applicant: Lockheed Martin Corporation, Bethesda, MD (US)

(72) Inventors: Nickolas Andrew Weingartner, Schwenksville, PA (US); Michael Robert Blithe, Newtown Square, PA (US)

(21) Appl. No.: 18/943,123

(22) Filed: Nov. 11, 2024

Related U.S. Application Data
(60) Provisional application No. 63/598,319, filed on Nov. 13, 2023.

(51) Int. Cl. H04L 9/00; G06Q 10/0631

(52) U.S. Cl. CPC H04L 9/50; G06Q 10/06312; G06Q 2220/00

(57) ABSTRACT

Provided herein are various enhancements for validating mission plans related to controlling operations of satellites from multiple sources. An example method includes obtaining an operational plan relating to logistical operations of one or more devices and performing a feasibility check for the operational plan based on logical rules implemented by a blockchain to determine a feasibility of an implementation of the logistical operations via the one or more devices. In response to satisfying the feasibility check, the method includes publishing the plan to the blockchain for subsequent execution.

### RELATED APPLICATIONS

This application hereby claims the benefit and priority to U.S. Provisional Application No. 63/598,319, titled “DECENTRALIZED MISSION PLANNING AND COMMAND AND CONTROL USING DECENTRALIZED FILE SYSTEMS AND BLOCKCHAIN,” filed Nov. 13, 2023, which is hereby incorporated by reference in its entirety.

### TECHNICAL BACKGROUND

The need for the capabilities of space-based assets across more users continues to increase. In addition, there are varying levels of ‘trust’ across the various users. However, with current mainstream space architectures, there is typically a single owner or operator of a given space-deployed system, which frequently corresponds to a centralized Command and Control (C2) and Mission Planning entity. This arrangement further increases scarcity over space resources, and can preclude use of assets by operators that do not establish operational trust with other entities to varying degrees.

While this arrangement allows for the more rapid standup of a system and is useful given the expense and burden of establishing space-based asset(s), it has several drawbacks. These drawbacks include the burden of maintenance and control resting on a single party, multiple parties with interests being kept in line via a gatekeeper, and prospective users being limited in number and functionality (i.e., all users need a dedicated/direct link into the system). Thus, centralization can lead to underutilization of assets, decreased resiliency, are difficult/slow to recover from outages/issues, and challenging to provide an active-active system. Centralized operators can provide application programming interfaces (APIs) to external users, but these APIs do not change the centralized nature of these space-deployed systems, still leading to underutilized resources and centralized C2 structures.

### SUMMARY

The descriptions disclosed herein provide enhanced techniques and systems for decentralized architectures for satellite system management. Specifically, the examples herein provide for a decentralized mission planning and command and control (C2) using decentralized file systems (DFS) and blockchain arrangements. Using such an architecture, each C2 and mission planning operator acts independently with respect to submitting and executing operational plans for deployed space asset(s), while also acting in tandem, without a single gatekeeper. Operational plans are evaluated against logical rules (e.g., smart contracts) implemented by the blockchain arrangement automatically upon submission of the operational plans. The logical rules include various rules and parameters agreed upon in advance by all the operators, and thus, the application of the logical rules eliminates the need for review by users each time an operational plan is submitted to the system. Upon validation of an operational plan, all operators are made aware of the operational plan, and a C2 user executes the operational plan to utilize the space asset(s) in accordance with the plan.

One example implementation includes an apparatus that includes a node having access to a blockchain. The node is configured to obtain an operational plan relating to logistical operations of one or more devices, perform a feasibility check for the operational plan based on logical rules implemented by the blockchain to determine a feasibility of an implementation of the logistical operations via the one or more devices, and in response to satisfying the feasibility check, publish the plan to the blockchain.

Another example implementation includes an apparatus having one or more computer-readable storage media and program instructions stored on the one or more computer-readable storage media executable by a processing device to direct the processing device to perform various functions. For example, the program instructions direct the processing device to obtain an operational plan relating to logistical operations of one or more devices, perform a feasibility check for the operational plan based on logical rules implemented by a blockchain to determine a feasibility of an implementation of the logistical operations via the one or more devices, and in response to satisfying the feasibility check, publish the plan to the blockchain.

In yet another example, a method of operating a node capable of accessing a blockchain is provided. The method includes obtaining an operational plan relating to logistical operations of one or more devices and performing a feasibility check for the operational plan based on logical rules implemented by the blockchain to determine a feasibility of an implementation of the logistical operations via the one or more devices. In response to satisfying the feasibility check, the method includes publishing the plan to the blockchain for subsequent execution.

This Overview is provided to introduce a selection of concepts in a simplified form that are further described below in the Detailed Description. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure can be better understood with reference to the following drawings. While several implementations are described in connection with these drawings, the disclosure is not limited to the implementations disclosed herein. On the contrary, the intent is to cover all alternatives, modifications, and equivalents.

FIG. 1 illustrates an exemplary operating environment in an implementation.

FIG. 2 illustrates a method of determining feasibility of an operational plan using a blockchain in an implementation.

FIG. 3 illustrates an operational sequence performed by elements of a mission planning and control system in an implementation.

FIG. 4 illustrates an exemplary block diagram of a decentralized mission planning and control system in an implementation.

FIG. 5 illustrates an exemplary aspect of a blockchain node and logical rules applied by the blockchain node in an implementation.

FIGS. 6A and 6B illustrate exemplary aspects of a blockchain node and logical rules implemented by the blockchain node in an implementation.

FIG. 7 illustrates an exemplary aspect of a user interface used in an implementation.

FIG. 8 illustrates a communication control system in an implementation.

### DETAILED DESCRIPTION

Disclosed herein are enhanced systems, devices, and methods related to deployed asset management, and in particular, to deployed space asset system management using a decentralized architecture to help overcome or alleviate various issues encountered with centralized command and control of controllable asset (e.g., satellite) systems. Specifically, the examples herein provide for a decentralized mission planning and command and control (C2) using decentralized file systems (DFS) and blockchain arrangements.

With a decentralized design, an architecture in which multiple tasking and C2 systems operate on a series of distributed nodes is provided, removing any single point of centralization. By decentralizing the system, each C2 and mission partner (MP) can act independently, while also working in tandem, without a single gatekeeper. New systems can be permissioned to the network but remain anonymous—no other nodes need to know who they are, or why they are tasking, and will only see the ‘bare minimum’ in the distributed ledger. Each node can be completely agnostic and from different vendors and systems—all that is needed is a consistent way to read from and write to a DFS node, and permission to be in the network and perform reads and writes.

By using a DFS as a backbone, alongside a smart contracts-enabled blockchain structure, the examples herein illustrate a new type of trustless architecture where mission planners and C2 systems share a DFS and ledger as a main form of ‘truth’, with smart contracts enforcing validations that keep operational assets safe. In this design, parties can share only what is needed with one another and remove the centralization of the operational system, distributing it over all permissioned parities. Advantageously, parties to this network can maintain their associated data private from one another, only choosing to ‘write’ or publish essential public information into the mission plan file, blockchain, and DFS. New nodes can be added by consensus, giving them the ability to plan and execute on the system, and removed, if parties are not contributing (for example, planning too many mission elements without contributions by executing portions of C2 plans). This can help to incentivize all parties in the network to care for the assets responsibly and sustainably. Multiple Mission Management (MM) and C2 systems can be from different providers. All that is needed is the node be permissioned into the specific DFS network to be able to participate.

In this enhanced architecture, each member—whether it be a mission planner, C2 system or other permissioned party—has access to a DFS and blockchain node, to which they have read/write access. The blockchain contains various smart contracts programmed in alongside a consensus scheme (e.g., proof-of-work, proof-of-stake). The smart contracts include a set of rules agreed upon by the members of the network, and the rules may be changed via the consensus scheme, if necessary. Depending on the type of write operation, a different smart contract is executed. As mission managers submit tasking requests into the shared networks, appropriate/applicable/interested C2 systems would create command loads that satisfied the tasking generated. The combination allows for the decentralized storage of a shared mission plan alongside a smart contracts-enabled blockchain.

As such, under this arrangement, multiple parties can be mission planners and C2 systems responsible for submitting plans to the DFS and blockchain nodes, proposing changes to the nodes, and executing validated plans based on the application of smart contracts implemented by the blockchain nodes against the plans. When a plan is submitted to the blockchain, a smart contract executes. A smart contract is self-executing program that lives within certain blockchain types that enable transactions to be dependent on passing a predetermined logical scenario. When a smart contract is completed and satisfied, the proposed plan is written into the DFS and referenced in the blockchain. Smart contracts play a role in maintaining the health and safety of the controllable assets, such as satellite(s)/constellation. In the examples herein, a smart contract could perform a feasibility check or assess feasibility of a proposed mission plan for controlling operations of one or more satellites, or the safety and non-parallel check to execute a plan. If these smart contract-based checks are passed, a content identifier (CID) is set as the shared source of truth and all nodes would be able to see this in a ledger of their blockchain node as well over time.

Further, any entity with access to the DFS or blockchain can make changes to a satellite ‘plan’. The plan may include any payload action, operational activity, tasking, function, on-board scheduling, sensor utilization, communication planning or operations, movement/orientation/orbital changes, on-board equipment changes/orientations, or other various activities related to operations and status of a satellite (or other controllable asset (e.g., vehicle, hardware/software device)). When something is changed (added, removed, altered, etc.) to an existing plan/file, the plan data is edited by a node, a new CID is obtained for the plan, then the updated plan and newly associated CID are published to the decentralized system. Feasibility checks are executed by the distributed system using smart contract rule checking. If feasible, the new plan is published to the blockchain or DFS as the new/current plan file. Feasibility checks can be done in blockchain itself, with smart contract logic incorporated into the blockchain, thus establishing a distributed logic check for plan changes. C2 parties can retrieve plan files from the blockchain/DFS, announce that a particular party will execute a quantity of identified commands (e.g., a portion of the plan), and publish this execution status to the blockchain. In this context, execution includes actually relaying commands to a satellite to command/control that satellite to perform activities related to the plan portion. In this manner, many C2 entities can perform activities for a single satellite or constellation of many satellites.

In various implementations, the feasibility checks are based on satellite/vehicle power models, capability specifications (e.g., sensors, movement options), orbits, ephemeris, status, telemetry, and other factors which compare the proposed plan changes against the satellite status for the timeframe associated with the plan changes. The feasibility checks via smart contracts ensure factors, such as keeping satellite momentum, power levels, and other key aspects are within predetermined boundaries to ensure that no proposed plan changes put the constellation or individual satellites at risk of failure or other unwanted problems. Inversely, on the C2 side, non-parallel execution of plan portions are guaranteed and validated to prevent execution collisions—ensuring that no more than one (1) C2 system will attempt to execute portions of plans at a time. If the plan changes are possible to be executed by the satellite during that timeframe, then the feasibility checks can be considered to be ‘passed’. Partial passing of the feasibility checks can result in errors or non-adding of the updated plan into the blockchain, among other notifications and actions.

To establish the feasibility checks, an entity associated with the satellites or constellation, such as an owner or operator, could publish a smart contract during initiation of the blockchain arrangement. Users of the satellites or constellation can then access a plan, and changes will be assessed against the parameters of the smart contract for feasibility logic checks. The smart contract (and associated feasibility checks) can be updated when satellite capabilities changes which affect the feasibility checks. For example, over time, the satellite fuel or functionality may degrade, orbital changes preclude or add different sets of functionality, and the like, which may alter capabilities of the assets.

In various implementations, the craft/vehicle/satellite capabilities correspond to achievable logistical or logical operations determined at least in part by orbital properties, ephemeris, trajectories, or on-board components, among other factors. Thus, the feasibility checks can correspond to one or more checks on the feasibility of one or more vehicles in implementing the proposed plan. For example, the feasibility checks can include determining if orbital properties of certain satellites support implementation of inter-satellite networks spanning those certain satellites, if on-board satellite components (e.g., network routing equipment and optical/RF communication equipment) of certain satellites support implementation of a communication routing plan, if orbital properties and on-board satellite components (e.g., sensors) can support implementation of a sensing/detection plan, or if on-board data processing equipment can support deployment of data payloads or sensor data processing workloads, among other capabilities and feasibility checks. As the plans can include logistical operations as well as logical or network/communications operations, the feasibility can span achievable physical operations as well as feasible logical/functional operations.

While the aforementioned scenarios are simplified for clarity, a large amount of functionality for the overall constellation viability may be implemented in smart contracts that ensure the deployed space-based assets themselves stay in orbit and avoid a ‘Tragedy of the Commons’ scenario, where all actors only care about their specific needs and put the entire system at risk through negligence or malfeasance. Consensus in initial stages would be resolved by time—the first to propose and have an accepted valid plan (in both mission planning and C2) can execute. However, this area can be built upon if desired by participants and be written into a smart contract as well. For example, levels of criticality can be considered or other ‘off-nominal’ use cases. Smart contracts are added via additional transactions—most would be setup during the initialization of the system and any changes to these can be handled via existing smart contract system rules.

One example implementation includes an apparatus that includes a node having access to a blockchain. The node is configured to obtain an operational plan relating to logistical operations of one or more devices, perform a feasibility check for the operational plan based on logical rules implemented by the blockchain to determine a feasibility of an implementation of the logistical operations via the one or more devices, and in response to satisfying the feasibility check, publish the plan to the blockchain.

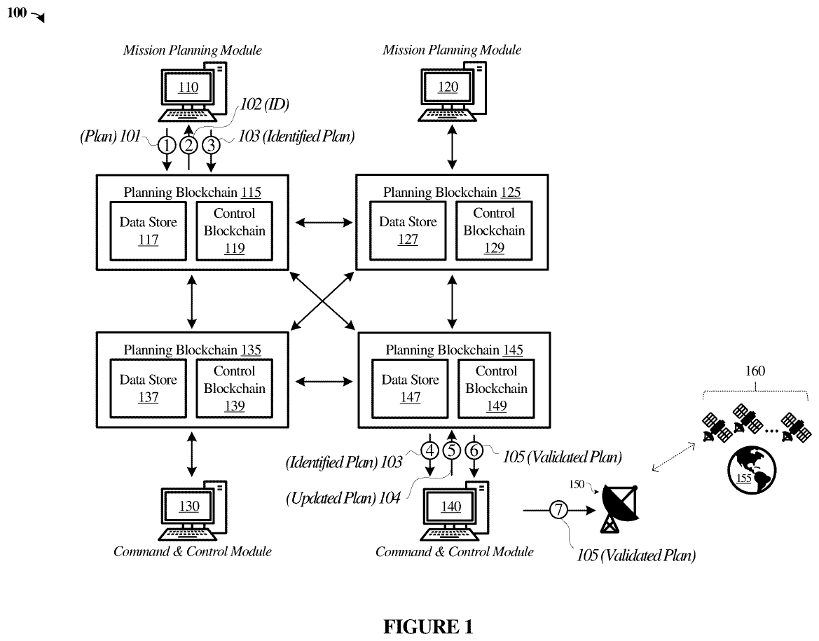

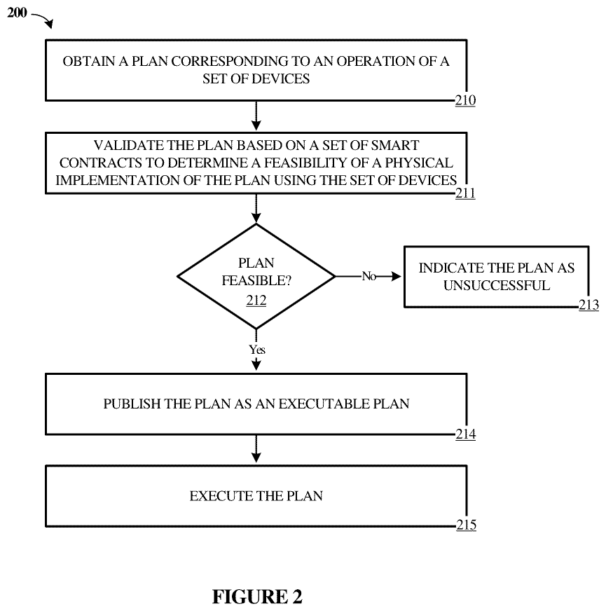

Turning now to the Figures, FIG. 1 illustrates operating environment 100 demonstrating a decentralized network of nodes each capable of accessing blockchain arrangements to submit operational plans to access a constellation of satellites. Operating environment 100 includes mission planning modules 110 and 120, planning blockchains 115, 125, 135, and 145, command and control modules 130 and 140, ground station 150, and satellites 160. In various examples, the command and control modules may be configured to perform mission plan submission processes, such as method 200 of FIG. 2.

Operating environment 100 is representative of a decentralized system for deployed asset system management in which multiple mission planning (e.g., mission planning module 110) and mission control (e.g., command and control module 130) actors have access to multiple nodes (e.g., data store 117, control blockchain 119) at which the actors can read and write plans related to operations of satellites 160 independently, and without intervention of a single, centralized gatekeeper. Each of the actors are able to participate in such a decentralized system based on a consensus among all of the actors in the system. As such, the system can be expanded to include additional actors and nodes so long as consensus is reached to add other members.

Mission planning modules 110 and 120 are representative of devices or systems capable of planning, configuring, and viewing operational missions involving satellites 160, among other deployed assets. Examples of such devices and systems include computing devices or apparatuses, such as computers, tablets, smartphones, and the like. Accordingly, mission planning modules 110 and 120 include various hardware, software, and/or firmware components, as well as combinations and variations thereof, to perform mission planning operations. Additionally, or alternatively, mission planning modules 110 and 120 may be representative of a mission planning application executable by a computing device to provide such functionality. Mission planning modules 110 and 120 may each include a user interface through which a user can create, modify, and write plans (e.g., plan 101) to planning blockchain 115 and planning blockchain 125, respectively.

Plan 101 is representative of an operational plan related to logistical operations of satellites 160. For example, plan 101 may include any payload action, operational activity, tasking, function, on-board scheduling, sensor utilization, communication planning or operations, movement/orientation/orbital changes, on-board equipment changes/orientations, or other various activities related to operations and status of a satellite (or other controllable asset (e.g., vehicle, hardware/software device)). Plan 101 may also include logistical information, such as timing information (e.g., start time, end time, duration), target information, and the like.

Command and control modules 130 and 140 are representative of devices or systems capable of viewing, modifying, and executing operational missions (e.g., plan 101) involving satellites 160. Examples of such devices and systems include computing devices or apparatuses, such as computers, tablets, smartphones, and the like. Accordingly, command and control modules 130 and 140 include various hardware, software, and/or firmware components, as well as combinations and variations thereof, to perform mission control operations. Additionally, or alternatively, command and control modules 130 and 140 may be representative of a mission control application executable by a computing device to provide such functionality. Command and control modules 130 and 140 may each include a user interface through which a user can view/read, modify, and write updated plans to planning blockchain 135 and planning blockchain 145, respectively, and through which a user can identify validated plans (e.g., validated plan 105) and execute validated plans.

Planning blockchains 115, 125, 135, and 145 are representative of multiple blockchain arrangements that provide distributed and decentralized ledgers accessible by mission planning module 110, mission planning module 120, command and control module 130, and command and control module 140, respectively. Each planning blockchain arrangement includes a distributed data store (e.g., a decentralized file system (DFS)) for storing operational plans, and related data and identifiers, and a control blockchain node for validating and publishing operational plans for execution thereof. In particular, planning blockchain 115 includes data store 117 and control blockchain 119, planning blockchain 125 includes data store 127 and control blockchain 129, planning blockchain 135 includes data store 137 and control blockchain 139, and planning blockchain 145 includes data store 147 and control blockchain 149. Each data store may be in communication with each other, and similarly, each control blockchain may be in communication with each other.

The data stores are representative of distributed data stores or file systems capable of storing operational plans and data and generating identifiers associated with plans (also referred to as content identifiers (CIDs)). In some example implementations, the data stores instead, or additionally, include numerous blockchain nodes at which the mission planning and command and control modules can write/read operational plans or reference operational plans and associated CIDs relative to the data stores. In further example implementations, the data stores instead include a decentralized file system (DFS) accessible by each of the modules.

The control blockchain nodes are representative of various nodes of a smart contracts-enabled blockchain structure (e.g., Ethereum). The control blockchain includes various smart contracts programmed in alongside a consensus scheme (e.g., proof-of-work, proof-of-stake). Each mission planning and/or command and control module can access the control blockchain to write an operational plan for evaluation against the smart contracts. Depending on the type of write operation, a different smart contract is executed. As mission managers (users of mission planning and/or command and control modules) submit plan requests into the control blockchain, the receiving control blockchain node performs feasibility checks using smart contract features to determine the feasibility of plan with respect to logical rules and conditions implemented into the smart contracts of the control blockchain.

In various implementations, the feasibility checks are based on satellite/vehicle power models, physical and logical capability specifications (e.g., sensors, movement options), orbits, ephemeris, status, telemetry, communication networks established between the satellites and/or between satellites and ground stations, and other factors which compare the proposed plan elements against the satellite status for the timeframe associated with the plan. The feasibility checks are determined by one or more of the parties to the decentralized system and are programmed into the control blockchain to eliminate gatekeeping by individual parties while allowing non-parallel execution of plans aligned with satellite capabilities and availability. Advantageously, the feasibility checks via smart contracts ensure factors, such as keeping satellite momentum, power levels, and other key aspects are within predetermined boundaries to ensure that no proposed plan changes put the constellation or individual satellites at risk of failure or other unwanted problems. If a plan is possible to be executed by satellites 160 during a proposed timeframe, then the control blockchain ‘passes’ or ‘approves’ the plan and publishes the plan on a blockchain ledger for all modules to view. The control blockchain may further output a notification to a module upon passing of the feasibility checks. However, partial passing of the feasibility checks can result in errors or non-adding of the plan into the blockchain ledger, among other notifications and actions.

Upon receiving an indication of success with respect to the feasibility checks, a command and control module in communication with satellites 160 can execute the plan such that satellites 160 performs operations in accordance with the plan. Executing the plan may include communicating the plan to ground station 150 and relaying the plan, via ground station 150, to satellites 160.

Satellites 160 may include any number of satellites in orbit around Earth 155 (e.g., low-Earth orbit) or a terrestrial object, in cislunar orbit, or in deep space. Each of satellites 160 may include hardware, software, and/or firmware elements to communicate with each other and ground station 150, to capture data during orbit, and to control operations of elements onboard satellites 160 per instructions from the command and control modules.

Also, although the term satellite is used herein, other controllable assets, such as controllable hardware, firmware, and/or software assets, may instead be employed. For example, other hardware devices can be employed, such as command and status ground hardware, and/or other vehicles can be employed, such as any spacecraft, space probes, satellites of various types and in various orbital configurations, and other spacefaring devices and deployed assets. Moreover, satellite devices can be included in sets or constellations which may be defined by orbital configuration groupings, or might be logical groupings of satellites, among other partitioning. Included in these sets may be other vehicles or devices which interface with satellites, such as aircraft, balloons, drones, unmanned aerial vehicles (UAVs), sea faring vessels, submarine vessels, terrestrial vehicles and stationary equipment (e.g., ground stations, facilities, installations), user equipment, computing devices, network equipment, and other various devices, vehicles, and equipment.

In operation, mission planning module 110 creates and writes plan 101 to data store 117. Data store 117 stores plan 101 and generates an ID 102 for plan 101. Data store 117 stores plan 101 in association with ID 102, both of which may be accessible for viewing and/or editing by other modules in the system via other respective data store nodes. Upon receiving ID 102, mission planning module 110 provides identified plan 103 (i.e., plan 101 with ID 102) to control blockchain 119.

Control blockchain 119 performs feasibility checks on identified plan 103 based on smart contracts implemented by control blockchain 119. For example, control blockchain 119 compares elements (e.g., activities, timing) of identified plan 103 to logical rules specified in the smart contracts. If identified plan 103 passes the feasibility checks, control blockchain 119 publishes identified plan 103 to the blockchain ledger and outputs an indication of success to the requesting module, mission planning module 110, and to a receiving module, such as command and control module 140. If identified plan 103 fails the feasibility checks, control blockchain 119 might not publish identified plan 103 to the blockchain ledger and may output an indication of failure to mission planning module 110.

Assuming the passing of the feasibility checks, command and control module 140 identifies the publishing of identified plan 103 to the control blockchain ledger and reads identified plan 103 from data store 147. Optionally, command and control module 140 can update identified plan 103 to change operational or logistical parameters of the plan. In an example where command and control module 140 updates identified plan 103, command and control module 140 creates updated plan 104, writes updated plan 104 to data store 147, and obtains a new ID associated with updated plan 104 from data store 147. The updated plan, in association with the new ID, now represents the source of truth for this particular plan on the blockchain ledgers. Then, command and control module 140 provides updated plan 104 and the new ID to control blockchain 149.

Control blockchain 149 performs feasibility checks on updated plan 104 based on smart contracts implemented by control blockchain 149. These smart contracts may be the same as the smart contracts implemented and applied by control blockchain 119 in the evaluation of identified plan 103. Upon passing of the feasibility checks, control blockchain 149 publishes updated plan 104 (referred to as validated plan 105 upon passing of the feasibility checks) to the blockchain ledger and notifies command and control module 140.

Command and control module 140 next executes validated plan 105. Accordingly, command and control module 140 provides validated plan 105 to ground station 150 and directs ground station 150 to transmit information specified in the plan to satellites 160 to control operations of satellites 160 in accordance with validated plan 105.

In some implementations, command and control module 140 might not update identified plan 103. As such, command and control module 140 may directly execute identified plan 103 based on the passing of the feasibility checks as indicated by control blockchain 119.

Advantageously, the decentralized system allows for any of multiple modules to generate, submit, and view plans for satellites 160 at any time. The plans can be validated against feasibility checks via smart contracts implemented by the control blockchain nodes without the need for each, or any, of the multiple modules to review and approve the plans in real-time. Rather, the validation of the plans can occur automatically in accordance with logical rules programmed into the smart contracts to provide seamless management of the plans and satellites 160. In this way, the application of the feasibility checks can avoid the scheduling of conflicting and infeasible plans, excessive submission of plans by the modules, and more, in alignment with real-time satellite capabilities.

Moving to FIG. 2, FIG. 2 illustrates a method of validating mission plans to control operations of satellites in an implementation. FIG. 2 includes method 200 noted parenthetically in the discussion below and which references elements of FIG. 1. In various examples, method 200 may be performed by one or more nodes (e.g., command and control module 140) capable of accessing a blockchain arrangement (e.g., planning blockchain 145). Method 200 may be executed by hardware software, firmware, or any combination or variation thereof.

In operation 210, command and control module 140 obtains (210) identified plan 103 from data store 147. Identified plan 103 is representative of an operational plan related to logistical operations of satellites 160 as well as an identifier assigned to the plan by a distributed file service (e.g., data store 117). In various implementations, identified plan 103 includes one or more payload actions, operational activities, tasking requests, functions, on-board scheduling, sensor utilization, communication planning or operations, movement/orientation/orbital changes, on-board equipment changes/orientations, or other various activities related to operations and status of a satellite. Identified plan 103 may also include logistical information, such as timing information (e.g., start time, end time, duration), target information, and the like.

Upon obtaining identified plan 103, command and control module 140 may optionally update the plan, such as by changing operational, timing, and/or logistical parameters of the plan. In such implementations, command and control module 140 stores the updated plan at data store 147. Data store 147 returns a new identifier for the updated plan and associates the updated plan with the new identifier for reference by other data store nodes and mission planning and command and control modules. Command and control module 140 then provides the updated plan and associated identifier to control blockchain 149.

In operation 211, command and control module 140 validates (211) identified plan 103 (or updated plan 104 if command and control module 140 updates the plan as in the optional step above) based on invoking smart contracts implemented by control blockchain 149. In particular, control blockchain 149 performs a feasibility check on identified plan 103 based on smart contracts to determine the feasibility of a physical implementation of identified plan 103 by satellites 160. The smart contracts include one or more sets of logical rules corresponding to actual satellite capabilities, status, telemetry, ephemeris, orbital properties, communication network properties, satellite-to-satellite relationships, satellite-to-ground relationships, and the like. Accordingly, the feasibility check compares plans elements proposed in identified plan 103 against the logical rules.

In operation 212, control blockchain 149 determines (212) whether identified plan 103 is feasible or not based on a result of the feasibility check. For example, the feasibility check may pass if identified plan 103 aligns with an available timeframe during which satellites 160 can operate, includes a set of operations performable by satellites 160 during the timeframe, and specifies a target location reachable by satellites 160 during the timeframe. Contrarily, the feasibility check may fail if identified plan 103 does not meet one or more conditions and/or capabilities set out in the smart contracts.

In operation 213, if control blockchain 149 determines the plan does not pass the feasibility check, control blockchain 149 indicates (213) that identified plan 103 is unsuccessful. This may entail indicating the failure of the feasibility check on a ledger of the control blockchain such that all other control blockchain nodes can view the status associated with identified plan 103. This may additionally entail providing a notification to command and control module 140, among other modules.

In operation 214, if control blockchain 149 determines the plan passes the feasibility check, control blockchain 149 publishes (214) identified plan 103 as an executable plan on the control blockchain ledger. This may additionally entail indicating the passing of the feasibility check on the event log of the control blockchain such that all other control blockchain nodes can view the status associated with identified plan 103. Further, this may also entail providing a notification to command and control module 140, among other modules.

In operation 215, command and control module 140 executes identified plan 103. In executing the plan, command and control module 140 provides the plan to ground station 150 and directs ground station 150 to transmit information specified in the plan to satellites 160 to control operations of satellites 160 in accordance with the plan.

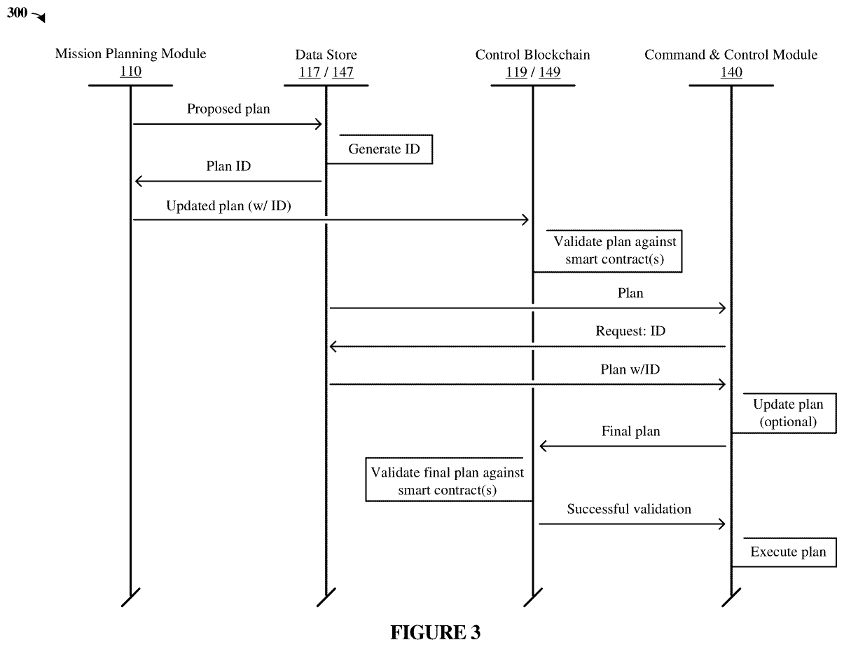

FIG. 3 illustrates sequence 300, which includes an example series of operational steps performable by elements of FIG. 1. Accordingly, sequence 300 includes and references elements of operating environment 100 of FIG. 1, such as mission planning module 110, data stores 117 and 147, control blockchains 119 and 149, and command and control module 140.

In sequence 300, mission planning module 110 begins by writing a proposed plan to data store 117. Data store 117 stores plan 101 and generates an ID for the proposed plan. Data store 117 stores the plan in association with the ID, both of which may be accessible for viewing and/or editing by other modules in the system via other respective data store nodes (e.g., data store 147). Upon receiving the ID from data store 117, mission planning module 110 provides the plan and the ID to control blockchain 119.

Control blockchain 119 performs feasibility checks on the plan based on smart contracts implemented by control blockchain 119. For example, control blockchain 119 compares elements (e.g., activities, timing) of the plan to logical rules specified in the smart contracts. If the plan passes the feasibility checks, control blockchain 119 publishes the plan to the blockchain ledger and outputs an indication of success to the requesting module, mission planning module 110, and to a receiving module in communication with asset(s) subject to the plan (satellites 160), such as command and control module 140. If the plan fails the feasibility checks, control blockchain 119 might not publish the plan to the blockchain ledger and may output an indication of failure to mission planning module 110.

Assuming the passing of the feasibility checks, command and control module 140 identifies the publishing of the plan to the control blockchain ledger and reads the plan from data store 147. Optionally, command and control module 140 can update the plan to change operational or logistical parameters of the plan. In an example where command and control module 140 updates the plan and provides a ‘final’ plan to data store 147. Command and control module 140 obtains a new ID associated with the updated plan from data store 147. The updated plan, in association with the new ID, now represents the source of truth for this particular plan on the blockchain ledgers. Then, command and control module 140 provides the updated plan and the new ID to control blockchain 149.

Control blockchain 149 performs feasibility checks on the final plan based on smart contracts implemented by control blockchain 149. These smart contracts may be the same as the smart contracts implemented and applied by control blockchain 119 in the evaluation of the initial plan proposed by mission planning module 110. Upon passing of the feasibility checks, control blockchain 149 publishes the final plan to the blockchain ledger and notifies command and control module 140.

Command and control module 140 next executes the validated plan. Command and control module 140 provides the validated plan to ground station 150 and directs ground station 150 to transmit information specified in the plan to satellites 160 to control operations of satellites 160 in accordance with the validated plan.

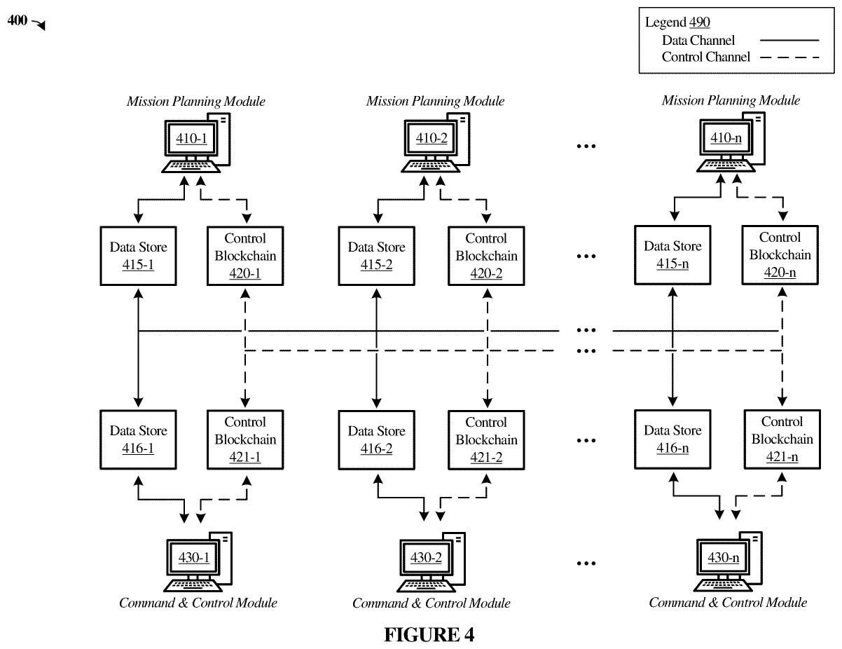

FIG. 4 illustrates block diagram 400 of an exemplary decentralized mission planning and control system and communication channels thereof. In FIG. 4, block diagram 400 includes mission planning modules 410-1, 410-2, and 410-n (collectively referred to as mission planning modules 410), data stores 415-1, 415-2, and 415-n (collectively referred to as data stores 415), data stores 416-1, 416-2, and 416-n (collectively referred to as data stores 416), control blockchain 420-1, 420-2, and 420-n (collectively referred to as control blockchains 420), control blockchains 421-1, 421-2, and 421-n (collectively referred to as control blockchains 421), and command and control modules 430-1, 430-2, and 430-n (collectively referred to as command and control modules 430).

Mission planning modules 410 are representative of devices or systems capable of planning, configuring, and viewing operational missions involving a set of assets (e.g., satellites 160). Examples of such devices and systems include computing devices or apparatuses, such as computers, tablets, smartphones, and the like. Accordingly, mission planning modules 410 each include various hardware, software, and/or firmware components, as well as combinations and variations thereof, to perform mission planning operations. Additionally, or alternatively, mission planning modules 410 may be representative of instances of a mission planning application executable by a computing device to provide such functionality. Mission planning modules 410 may each include a user interface through which a user can create, modify, and write plans (e.g., plan 101) to respective ones of data stores 415 and control blockchains 420.

Command and control modules 430 are representative of devices or systems capable of viewing, modifying, and executing operational missions (e.g., plan 101) involving the set of assets. Examples of such devices and systems include computing devices or apparatuses, such as computers, tablets, smartphones, and the like. Accordingly, command and control modules 430 each include various hardware, software, and/or firmware components, as well as combinations and variations thereof, to perform mission control operations. Additionally, or alternatively, command and control modules 430 may be representative of instances of a mission control application executable by a computing device to provide such functionality. Command and control modules 430 may each include a user interface through which a user can view/read, modify, and write updated plans to respective ones of data stores 416, and through which a user can identify validated plans and execute validated plans.

Data stores 415 and 416 are representative of distributed data stores or file systems that provides distributed file services accessible by mission planning modules 410 and command and control modules 430, respectively. In particular, mission planning module 410-1 is capable of accessing data store 415-1 over a data channel (in accordance with legend 490), mission planning module 410-2 is capable of accessing data store 415-2 over a data channel, mission planning module 410-n is capable of accessing data store 415-n over a data channel, command and control module 430-1 is capable of accessing data store 416-1 over a data channel, command and control module 430-2 is capable of accessing data store 416-2 over a data channel, and command and control module 430-n is capable of accessing data store 416-n over a data channel. Each data store node is also in communication with one another over data channels.

Control blockchains 420 and 421 are representative of nodes of a blockchain arrangement that provides consensus checks for new modules attempting to the join the system, and feasibility checks for operational plans submitted to nodes of the blockchain arrangement. In particular, mission planning module 410-1 is capable of accessing control blockchain 420-1 over a control channel (in accordance with legend 490), mission planning module 410-2 is capable of accessing control blockchain 420-2 over a control channel, mission planning module 410-n is capable of accessing control blockchain 420-n over a control channel, command and control module 430-1 is capable of accessing control blockchain 421-1 over a control channel, command and control module 430-2 is capable of accessing control blockchain 421-2 over a control channel, and command and control module 430-n is capable of accessing control blockchain 421-n over a control channel. Each control blockchain node is also in communication with one another over control channels.

Each node of control blockchains 420 and 421 implement smart contract features with which the nodes can perform the feasibility checks to determine the feasibility of a plan for implementation by the set of assets. Upon passing of a feasibility check, the control blockchains 420 and 421 maintain a ledger indicating validated plans to be executed by one of command and control modules 430. Thus, the control blockchains 420 and 421 provide transparency and visibility into the operations of the set of assets, while also providing review and evaluation processes as opposed to a single gatekeeper as in centralized systems.

As illustrated in block diagram 400, a decentralized system for satellite system management may include any number of mission planning modules 410 and command and control modules 430 that can propose, edit, and execute plans to operate group(s) of satellites. Each module may have access to the distributed file system and control blockchain arrangement via individual respective nodes, each of which may be capable of communicating with other nodes of the same type in the system.

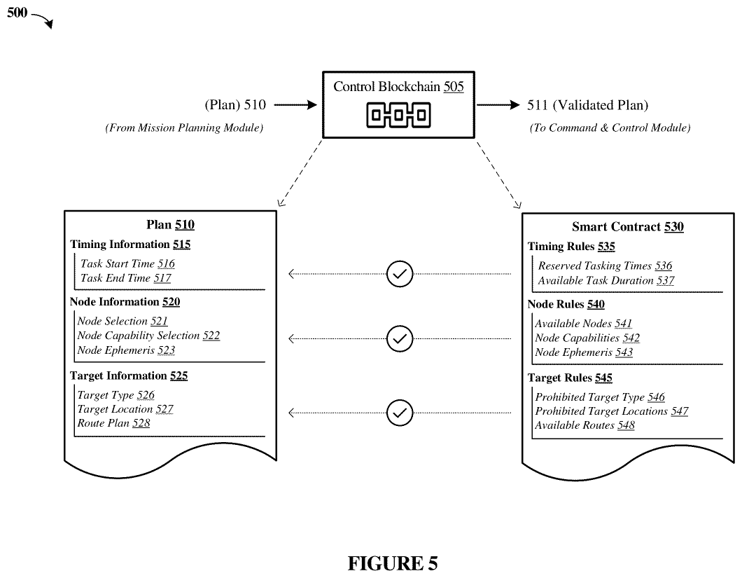

FIG. 5 illustrates operating environment 500 demonstrating an aspect of a control blockchain in a decentralized mission planning and control system. Operating environment 500 shows control blockchain 505, and inputs and outputs to control blockchain 505, such as proposed tasking plan 510 and smart contract 530. Control blockchain 505 may be implemented in a decentralized mission planning and control system, such as in one or more elements of operating environment 100 of FIG. 1 and/or block diagram 400 of FIG. 4.

Control blockchain 505 is representative of a blockchain node among several blockchain nodes in a smart contracts-enabled blockchain structure. For example, control blockchain 505 represents a node coupled to a mission planning system (e.g., mission planning module 110) or a command and control system (e.g., command and control module 140) and configured to receive plan 510. Control blockchain 505 includes various smart contracts programmed in alongside a consensus scheme (e.g., proof-of-work, proof-of-stake) with which to perform feasibility checks against plans proposed to control blockchain 505.

Smart contract 530 represents an example smart contract implemented by control blockchain 505, which control blockchain 505 can use to validate plan 510. Smart contract 530 includes timing rules 535, node rules 540, and target rules 545. In various implementations, smart contract 530 may be invoked based on the type of plan 510, or the type of write operation to control blockchain 505 associated with plan 510.

Timing rules 535 include reserved tasking times 536 and available task duration 537, among other timing-related rules. Reserved tasking times 536 indicate time windows during which the satellites (or other controllable assets (e.g., vehicles, hardware/software devices)) are unavailable for use. Available task duration 537 refers to a maximum length of time a given plan can request use of the satellites.

Node rules 540 include available nodes 541, node capabilities 542, and node ephemeris 543. Available nodes 541 indicates information about satellites that are available for use during a given time. For example, available nodes 541 indicates a number of operable satellites among a constellation as well as types and/or models of the satellites. Node capabilities 542 indicate capability specifications (e.g., sensors, movement options) of each of the satellites available for use during a given time. For example, node capabilities 542 may include physical capabilities of the satellites, logical capabilities of the satellites, capability properties and characteristics, relationship information between satellites in the constellation and satellites and ground stations, and more. Node ephemeris 543 indicates telemetry and ephemeris data associated with the available satellites, as well as operational information, flight status information, and orbital properties of the available satellites.

Target rules 545 include prohibited target type 546, prohibited target locations 547, and available routes 548. Prohibited target type 546 indicates types of targets (e.g., buildings, structures) unable to be selected as subject of a plan. Prohibited target locations 547 similarly indicate types of locations (e.g., geographical locations) unable to be navigated to or otherwise unable to be subject of a plan. Available routes 548 indicate routes and movements available to be used in a plan to navigate to a location.

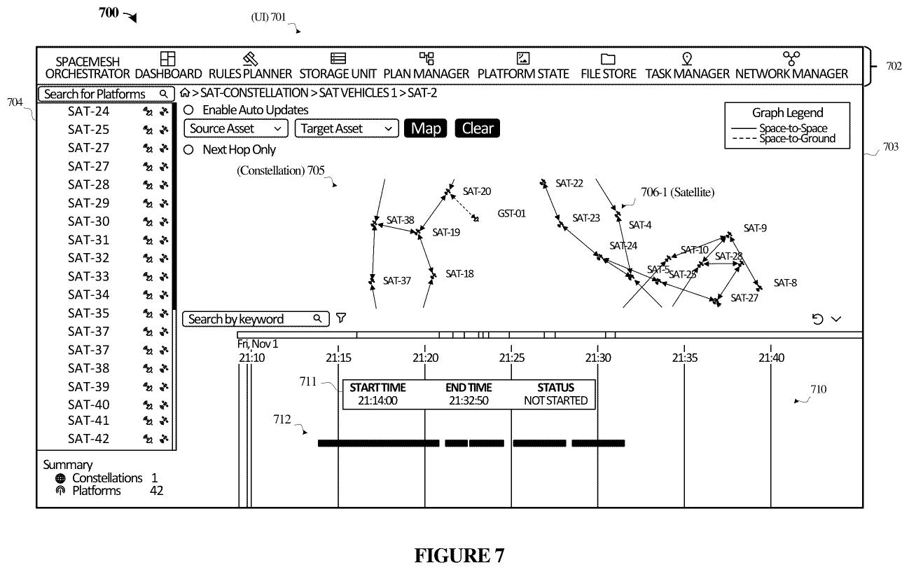

Plan 510 includes various elements that detail the logistical and operational activities of plan 510, such as timing information 515, node information 520, and target information 525. The elements of plan 510 may be selected by a user using a user interface (e.g., user interface 701 of FIG. 7 below).

Timing information 515 includes task start time 516 and task end time 517, both of which relate to timing parameters of operations indicated in plan 510. A duration of the operations indicated in plan 510 can be determined based on task start time 516 and task end time 517.

Node information 520 includes node selection 521, node capability selection 522, and node ephemeris 523. Node selection 521 indicates a number of satellites chosen for the operations. This may include some or all of the satellites among a constellation in orbit. Node capability selection 522 indicates a type of operation or task (e.g., image capture, data capture, sensor measurement), a type of sensor for use in performing the task, or other capabilities to be used/performed to carry out the plan. Node ephemeris 523 indicates a planned ephemeris of the selected satellites.

Target information 525 includes target type 526, target location 527, and route plan 528. Target type 526 indicates a target, and a type thereof selected in the plan, and target location 527 indicates the location of the selected target. Route plan 528 indicates desired logistical routes with which to navigate the satellites to the selected target.

In performing a feasibility check using smart contract 530, control blockchain 505 may be configured to compare elements of plan 510 to related rules of smart contract 530. For example, control blockchain 505 compares timing information 515 to timing rules 535, node information 520 to node rules 540, and target information 525 to target rules 545. By way of example, if plan 510 specifies a timeframe between task start time 516 and task end time 517 within one or more unavailable time windows (based on reserved tasking times 536), control blockchain 505 can determine that plan 510 fails the feasibility check. By way of another example, if plan 510 identifies a capability in node capability selection 522 that the selected satellites cannot perform (based on node capabilities 542), control blockchain 505 can determine that plan 510 fails the feasibility check. For example, plan 510 may indicate a desire to capture images of a target while the selected satellites do not have imaging equipment onboard. It follows that plan 510 may be required to satisfy all rules and conditions set by smart contract 530 to pass the feasibility check. Based on satisfying the rules of smart contract 530, control blockchain 505 can output an indication of validation to a command and control module for the command and control module to execute validated plan 511.

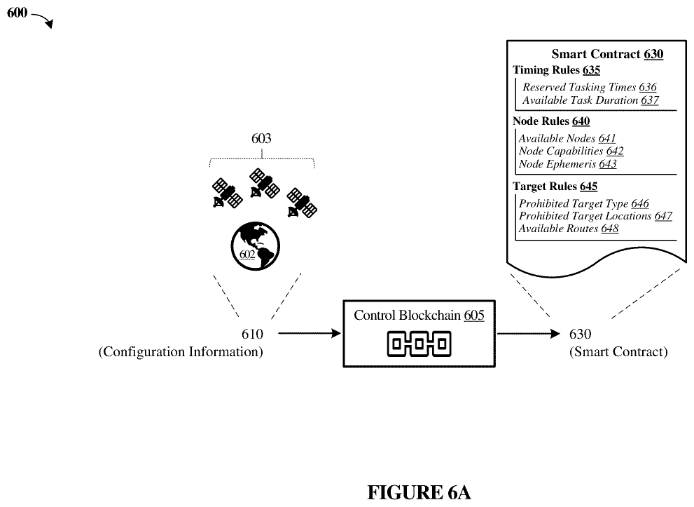

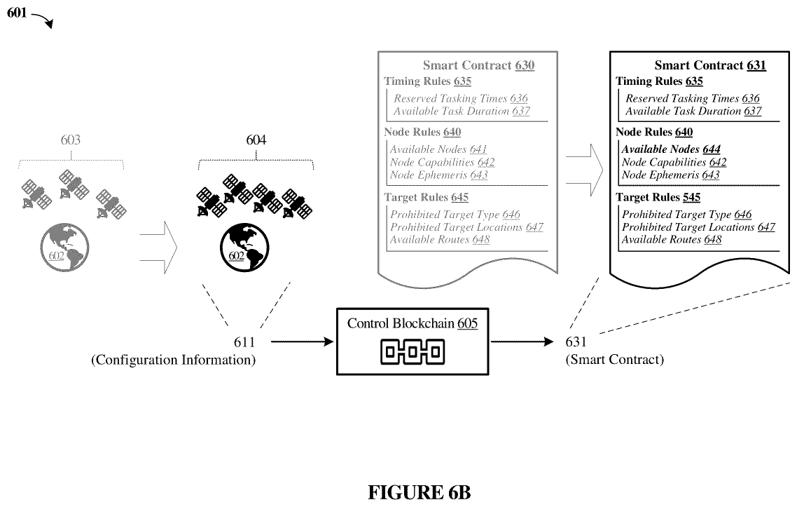

FIGS. 6A and 6B illustrate operating environments 600 and 601, respectively, demonstrative of aspects of a control blockchain in a decentralized mission planning and control system. Operating environment 600 shows control blockchain 605, which implements smart contract 630 based on configuration information 610. Operating environment 601 shows control blockchain 605, which implements smart contract 631 based on configuration information 611. Control blockchain 605 may be implemented in a decentralized mission planning and control system, such as in one or more elements of operating environment 100 of FIG. 1 and/or block diagram 400 of FIG. 4.

Control blockchain 605 is representative of a blockchain node among several blockchain nodes in a smart contracts-enabled blockchain structure. For example, control blockchain 605 represents a node coupled to a mission planning system (e.g., mission planning module 110) or a command and control system (e.g., command and control module 140) and configured to receive configuration information 610. Control blockchain 605 includes various smart contracts programmed in alongside a consensus scheme (e.g., proof-of-work, proof-of-stake) with which to perform feasibility checks against plans (e.g., plan 101, plan 510) proposed to control blockchain 605.

Smart contract 630 represents an example smart contract implemented by control blockchain 605 and based on configuration information 610, which control blockchain 605 can use to validate plans submitted to control blockchain 605. Smart contract 630 includes timing rules 635, node rules 640, and target rules 645. In various implementations, smart contract 630 may be invoked based on the type of plan, or the type of write operation to control blockchain 605 associated with the plan.

Timing rules 635 include reserved tasking times 636 and available task duration 637, among other timing-related rules. Reserved tasking times 636 indicate time windows during which the satellites 603 (or other controllable assets (e.g., vehicles, software/hardware devices)) are unavailable for use. Available task duration 637 refers to a maximum length of time a given plan can request use of the satellites.

Node rules 640 include available nodes 641, node capabilities 642, and node ephemeris 643. Available nodes 641 indicates information about satellites that are available for use during a given time. For example, available nodes 641 indicates a number of operable satellites 603 among a constellation as well as types and/or models of the satellites. Node capabilities 642 indicate capability specifications (e.g., sensors, movement options) of each of the satellites available for use during a given time. Node ephemeris 643 indicates telemetry and ephemeris data associated with the available satellites, as well as operational and flight status information of the available satellites.

Target rules 645 include prohibited target type 646, prohibited target locations 647, and available routes 648. Prohibited target type 646 indicates types of targets (e.g., buildings, structures) unable to be selected as subject of a plan. Prohibited target locations 647 similarly indicate types of locations (e.g., geographical locations) unable to be navigated to or otherwise unable to be subject of a plan. Available routes 648 indicate routes and movements available to be used in a plan to navigate to a location.

In various implementations, smart contract 630 is programmed into control blockchain 605 such that upon receiving a plan, control blockchain 605 applies smart contract 630 when performing feasibility checks against the plan. In such implementations, smart contract 630 is based on configuration information 610, which may indicate timing information, node information, and target information, among other information, related to satellites 603. By way of example, configuration information 610 may include a number of satellites 603, a type or model of satellites 603, telemetry and ephemeris data of satellites 603 in orbit around Earth 602, capabilities of satellites 603, capability specifications and equipment onboard satellites 603, and more.

Referring next to FIG. 6B, FIG. 6B shows operating environment 601 in which the available satellites, and potentially the satellite capabilities, change resulting in updated configuration information 611, and consequently, updated smart contracts implemented by control blockchain 605.

As illustrated in operating environment 601, satellites 603 expand from three satellites in-orbit to four satellites in-orbit around Earth 602. Based on changes to the constellation of satellites, configuration information 611 is now provided to control blockchain 605. Configuration information 611 indicates at least a different number of satellites relative to configuration information 610. In some implementations, configuration information 611 may also indicate changes in satellite capabilities, satellite telemetry and/or ephemeris, and the like based on the expansion of the constellation.

As a result of receiving configuration information 611, control blockchain 605 updates smart contract 630 to produce smart contract 631. Smart contract 631 may include some or all of the same logical rules as smart contract 630. However, based on the size of the constellation of satellites increasing, smart contract 631 includes available nodes 644 that indicates a different combination of satellites available for use. Other changes to configuration information 611 may also influence smart contract 631.

FIG. 7 illustrates an exemplary aspect of user interface (UI) 701 used in an implementation. FIG. 7 includes UI 701, which includes function toolbar 702, display window 703, asset list 704, and operational graph 710. In various examples, UI 701 may be presented in a computing device or system, such as any of the mission planning modules (e.g., mission planning module 110) or command and control modules (e.g., command and control module 140) of FIG. 1.

In use, UI 701 can provide a visual representation of assets in a system, such as satellites 706 in constellation 705, and functions of an application presented through UI 701. Function toolbar 702 may include one or more icons representative of different functions or views that can be navigated through by interacting with UI 701 (e.g., touch, click, tap, swipe). For example, function toolbar 702 includes icons representative of a dashboard function, a rules planner function, a storage unit function, a plan manager function, a platform state function, a file store function, a task manager function, and a network manager function, among other functions and views. Upon interacting with an option of function toolbar 702, UI 701 may present a visual representation on display window 703.

In aspect 700, UI 701 shows an example visual representation of constellation 705 on display window 703. Constellation 705 may include a number of satellites 706 arranged in orbit. However, display window 703 may show only a portion of satellites 706 as UI 701 may present a zoomed-in view of constellation 705 in aspect 700. Asset list 704 may include a list of satellites 706, among other space-deployed assets, ground stations, and the like. Each satellite of constellation 705 may communicate with one or more other neighboring satellites in constellation 705. The lines connecting each satellite in the visual representation shown in display window 703 may represent communication paths between the satellites.

UI 701 may include operational graph 710 in a portion of display window 703. Operational graph 710 includes operational information 711 related to operations of satellites 706, such as a start time of an operation, an end time of operations, and a status of an operation (e.g., not started, in progress, completed).

Operational graph 710 also includes a timewise view 712 of states of constellation 705 with respect to time. The states of constellation 705 may refer to positions and orientations of satellites 706 relative to one another and to earth, the moon, or other terrestrial objects, or to specific terrestrial locations, such as ground stations, which may be identified using telemetry data, ephemeris data, and/or calculated trajectories of each satellite. In a proposed plan, various states of satellites 706 may be identified in timewise view 712, where each state refers to an operational or logistical position corresponding to a duration.

In UI 701, a user may view current positioning of satellites 706 of constellation 705. Further, the user may also generate tasking plans for satellites 706, including by mapping desired routes, identifying targeted locations, requesting performance of specific operations, and the like for any number of satellites 706 over a timeframe. The user can save the plan in a data store, or some other distributed file system, for execution by a command and control module user downstream upon approval of the plan by a control blockchain arrangement (e.g., control blockchain 149).

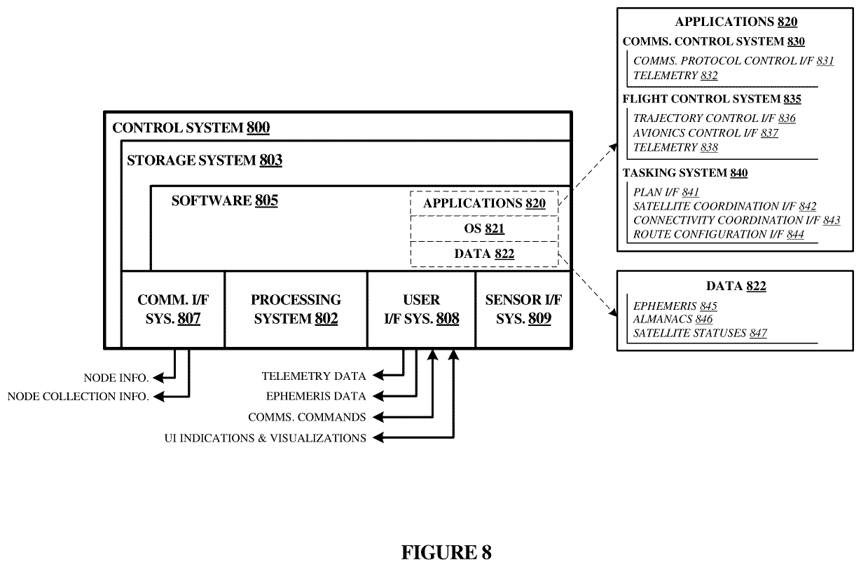

FIG. 8 illustrates control system 800 and associated software 805 in an implementation. FIG. 8 illustrates control system 800 that is representative of any system or collection of systems in which the various operational architectures, scenarios, and processes disclosed herein may be implemented. For example, control system 800 can be used to implement elements of mission planning modules 110 and 120, command and control modules 130 and 140, and planning blockchains 115, 125, 135, and 145, as well as each node thereof, of FIG. 1, mission planning modules 410, data stores 415, control blockchains 420, and command and control modules 430 of FIG. 4, control blockchain 505 of FIG. 5, control blockchain 605 of FIGS. 6A and 6B, and user interface 701 of FIG. 7.

Control system 800 may be implemented as a single apparatus, system, or device or may be implemented in a distributed manner as multiple apparatuses, systems, or devices. Control system 800 includes, but is not limited to, processing system 802, storage system 803, software 805, communication interface system 807, user interface system 808, and sensor interface system 809. Processing system 802 is operatively coupled with storage system 803, communication interface system 807, user interface system 808, and sensor interface system 809.

Processing system 802 loads and executes software 805 from storage system 803. Software 805 includes applications 820, which are representative of the processes, services, and platforms discussed with respect to the included Figures. When executed by processing system 802 to obtain and validate an operational plan to determine the feasibility of the implementation of the plan by a set of assets, among other services, software 805 directs processing system 802 to operate as described herein for at least the various processes, operational scenarios, and sequences discussed in the foregoing implementations. Control system 800 may optionally include additional devices, features, or functionality not discussed for purposes of brevity.

Referring still to FIG. 8, processing system 802 may comprise a microprocessor and processing circuitry that retrieves and executes software 805 from storage system 803. Processing system 802 may be implemented within a single processing device but may also be distributed across multiple processing devices or sub-systems that cooperate in executing program instructions. Examples of processing system 802 include general purpose central processing units, application specific processors, and logic devices, as well as any other type of processing device, combinations, or variations thereof.

Storage system 803 may comprise any computer readable storage media readable by processing system 802 and capable of storing software 805. Storage system 803 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal. In addition to computer readable storage media, in some implementations storage system 803 may also include computer readable communication media over which at least some of software 805 may be communicated internally or externally. Storage system 803 may be implemented as a single storage device but may also be implemented across multiple storage devices or sub-systems co-located or distributed relative to each other. Storage system 803 may comprise additional elements, such as a controller, capable of communicating with processing system 802 or possibly other systems.

Software 805 may be implemented in program instructions and among other functions may, when executed by processing system 802, direct processing system 802 to operate as described with respect to the various operational scenarios, sequences, and processes illustrated herein. For example, software 805 may include program instructions comprising applications 820, operating system 821, and data 822 that provide validation of plans related to operations of a constellation of satellites, among other services. In particular, the program instructions may include various components or modules that cooperate or otherwise interact to carry out the various processes and operational scenarios described herein. The various components or modules may be implemented in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 805 may include additional processes, programs, or components, such as operating system software or other application software, in addition to or that include applications 820. Software 805 may also comprise firmware or some other form of machine-readable processing instructions executable by processing system 802.

Software 805, when loaded into processing system 802 and executed, may transform a suitable apparatus, system, or device (of which control system 800 is representative) overall from a general-purpose computing system into a special-purpose computing system customized to provide validation of operational plans, among other services. Indeed, encoding software 805 on storage system 803 may transform the physical structure of storage system 803. The specific transformation of the physical structure may depend on various factors in different implementations of this description. Examples of such factors may include, but are not limited to, the technology used to implement the storage media of storage system 803 and whether the computer-storage media are characterized as primary or secondary storage, as well as other factors. For example, if the computer-readable storage media are implemented as semiconductor-based memory, software 805 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Applications 820 can include communications control system 830, flight control system 835, and tasking system 840. Communications control system 830 includes communications protocol control interface 831 and telemetry 832. Flight control system 835 includes trajectory control interface 836, avionics control interface 837, and telemetry 838. Tasking system 840 includes plan interface 841, satellite coordination interface 842, connectivity coordination interface 843, and route configuration interface 844.

Turning first to communications control system 830, communications protocol control interface 831 can direct operation of onboard communications equipment, sensor equipment, and other onboard devices based on operational plan elements provided to communications protocol control interface 831. Telemetry 832 can be configured to collect and store instrumentation data for further transfer during operations of a satellite during orbit.

Turning next to flight control system 835, trajectory control interface 836 may be configured to determine one or more maneuvers and velocities to perform the one or more maneuvers of a satellite. Avionics control interface 837 may be configured to enable operation of onboard instruments and equipment of a satellite during flight and in-orbit operations. Examples of the instruments and equipment may include optical imagers, sensors, gyroscopic/accelerometer, and other elements. Telemetry 838 can be configured to collect and store instrumentation data for further transfer during operations of a satellite during orbit.

Turning next to tasking system 840, plan interface 841 may be configured to receive plans from a user/module/client indicating a desire for performance of tasking operations, logistic operations, sensor capture operations, and the like based on plans. Satellite coordination interface 842 may be configured to identify states of the satellites in the constellation, a state of the constellation, and coordinate plans for one or more of the satellites based on the states. Connectivity coordination interface 843 may be configured to generate network contacts among satellites and ground stations during a timeframe indicated in a plan to communicate data between the satellites and the ground stations during operation. Route configuration interface 844 may be configured to create routing tables for the constellation during the timeframe when performing operations of the plan. Route configuration interface 844 may further be configured to utilize routing tables to create projected routes and maneuvers required to carry out the plan.

Data 822 may include various information related to one or more satellites in a constellation and communication network parameters for configuring communication pathways therewith. Data 822 includes ephemeris 845, almanacs 846, and satellite statuses 847. Ephemeris 845 may include ephemeris data related to each satellite in a constellation, including current positions and orientations and projected trajectories. Almanacs 846 may include sets of parameters for configuring communication networks among satellites in a constellation. Satellite statuses 847 may include state and status information of each satellite in a constellation corresponding to operational status, instrumentation status, and the like.

Communication interface system 807 may include communication connections and devices that allow for communication with other computing systems or electrical components (not shown) over communication links or communication networks (not shown). Examples of connections and devices that together allow for inter-system communication may include transceivers, network interface controllers, antennas, power amplifiers, RF circuitry, and other communication circuitry. The connections and devices may communicate over communication media to exchange communications with other computing systems or networks of systems, such as metal, glass, air, or any other suitable communication media. Physical or logical elements of communication interface system 807 can provide constellation information, satellite router information, and other information.

Communication interface system 807 may include portions of sensor system interface 809. Sensor system interface 809 comprises various hardware and software elements for interfacing with satellite instrumentation, avionics, sensors, networking devices, and other devices. For example, sensor system interface 809 can receive or obtain position, gyroscope and/or accelerometer data, instrumentation collection data, and the like. Data processing elements or other equipment can be included in sensor system interface 809.

Communication between communication control system 800 and other elements or systems (not shown), may occur over communication links or communication networks and in accordance with various communication protocols, combinations of protocols, or variations thereof. For example, communication control system 800 when implementing a control device, might communicate with sensor elements over corresponding digital communication links comprising Ethernet interfaces, serial interfaces, serial peripheral interface (SPI) links, inter-integrated circuit (I2C) interfaces, universal serial bus (USB) interfaces, UART interfaces, or wireless interfaces. When network links are employed, example networks include intranets, internets, the Internet, local area networks, wide area networks, wireless networks, wired networks, virtual networks, software defined networks, data center buses, computing backplanes, or any other type of network, combination of network, or variation thereof. The aforementioned communication networks and protocols are well known and need not be discussed at length here. However, some network communication protocols that may be used include, but are not limited to, the Ethernet, Internet protocol (IP, IPv4, IPv6, etc. . . . ), the transmission control protocol (TCP), and the user datagram protocol (UDP), as well as any other suitable communication protocol, variation, or combination thereof.

User interface system 808 may include a software or virtual interface such as a terminal interface, command line interface, or application programming interface (API). User interface system 808 may also include physical user interfaces, such as keyboard, a mouse, a voice input device, or a touchscreen input device for receiving input from a user. User interface system 808 may include telemetry interfaces, ephemeris interfaces, user command controls, router operation mode command controls, and user interface indications, visualizations, and representations, among others. Output devices such as displays, web interfaces, terminal interfaces, and other types of output devices may also be included in user interface system 808. User interface system 808 can provide output and receive input over a network interface, such as communication interface system 807. In network examples, user interface system 808 might packetize data for receipt by a display system or computing system coupled over one or more network interfaces. User interface system 808 may comprise API elements for interfacing with users, other data systems, other user devices, web interfaces, and the like. User interface system 808 may also include associated user interface software executable by processing system 802 in support of the various user input and output devices discussed above. Separately or in conjunction with each other and other hardware and software elements, the user interface software and user interface devices may support a console user interface, graphical user interface, a natural user interface, or any other type of user interface.

While the elements of control system 800 are generally applicable to be used to implement elements of the mission planning and control aspects of the above Figures, the satellites/vehicles (e.g., satellites 160) controlled by such mission planning and control elements also include various computing hardware, software, and firmware elements to carry out respective operations. For example, the satellites/vehicles include various logistical components, communication components, and processing (e.g., data processing) components.

The logistical components can include propulsion equipment, navigation equipment, station-keeping equipment, or telemetry equipment, among other equipment. The communication components can include in-plane and cross-plane routing equipment, optical communication equipment, radio frequency (RF) equipment, or network communication equipment, among other equipment. The processing components may include data processors (e.g., central processing units (CPUs), general purpose processors, graphical processing units (GPUs), digital signal processors (DSPs), field programmable logic arrays (FGPAs), application specific integrated circuits (ASICs)), storage devices and systems, or memory, among other equipment. Sensing equipment can include sensors, sensor data pre-processors, sensor data buffers, or data conversion equipment, among other equipment.

In this new architecture several key benefits emerge that differentiate it significantly from a traditional centralized architecture. These include trustless joint custody (many can now ‘own’ the asset(s), coordinating independently and in tandem without explicit coordination to sustain and utilize it); limited information sharing (when creating a plan, each node only must share the ‘essentials’ and can keep the other information private); and pseudo-anonymity (to join, one needs to be permissioned into the network, but one does not have to reveal an identity to others in the network).

Building on these benefits, some key interesting use cases arise.

### Trustless Joint Custody of Assets Use Case

As alluded to in previous sections, this architecture enables multiple parties to participate in the mission planning, command and control (C2), and reading of needs. In situations of ‘lower trust’ compared to centralized ones, one could imagine several parties sharing assets (and therefore, getting access to assets they would otherwise not have access to) that would optimize resource usage. For example, these could include assets held between allied nations (like NASA, JAXA and ESA, or FVEY, NATO) or even intra-agency with one customer. A constellation can be effectively ‘owned’ by many entities, enabling more access to limited resources and cheaper access for all. This can establish expense mitigation and share satellites that are co-owned or funded across entities. Timesharing can be established among anonymous entities or users, even within same organization.

### Edge Node in the Field Use Case

There may be scenarios when ‘edge’ systems, like one in the field, may want to plan or command an asset(s). In this scenario, a lightweight system could be built around a permissioned node, which can be carried locally. Once the DFS and blockchain nodes propagate (perhaps with intermittent connectivity), the edge system can effectively control the asset as an equal member. Lightweight distributed (and/or dispensable) systems could be put into the field, with intermittent connectivity. These systems can write to their local node and system which will synchronize up over time to execute a plan.

### Resilient Systems Use Case

Even for a system ‘owned’ by one entity, implementing a decentralized architecture like this can make the overall system more resilient. Nodes can be spread across various geographies and systems, and in the event of one or more systems being destroyed or removed, the other systems can seamlessly continue in their mission, as new nodes are added again. Even if implemented by a single ‘owner’, this could mean systems that have no single points of failure, making recovery from disaster scenarios more likely and rapid. Moreover, replicated flight planning/task planning can avoid a single point of failure when a single C2 is employed.

### Systems of Systems Retrofitting Use Case

In cases where there are several distinct systems, it is possible to implement this architecture in a way that allow the systems to interact with one another even though they were built independently. By implementing an DFS node as well as some wrapping code around their current system, many systems can coordinate their assets into a larger System-of-Systems (SoS). In this scenario, implementing a decentralized ‘connector’ would help the systems to operate more cohesively with one another. Implementing this method could result in easier SoS integration, given the low impact touch points—each system could be enhanced slightly to talk to a local node, and the decentralized architecture could sync it up to make the overall retrofitting cheaper. Thus, this architecture can tie together different types of systems and tie together different types of end users.

In addition, various encryption schemes can be introduced, allowing each blockchain node to encrypt each write into the system, with only the smart contracts themselves having the public keys to decrypt and compute. This would keep even the ‘core’ actions encrypted from each node and other external parties. Homomorphic or semi-homomorphic encryption could be employed. The architecture herein could be extended to support processing, utilizing the same DFS core to distribute processing responsibilities across many nodes.

Although the term DFS is employed herein, various types of DFS examples can be used. One example includes the InterPlanetary File System (IPFS). IPFS is a protocol and system for storing and sharing files on a distributed peer-to-peer network, such as on a blockchain. Various types of blockchains can be employed, such as those that support smart contracts or can be augmented to support smart contracts. Examples include Ethereum, Hyperledger Fabric, StellarRootstock, modified versions of Bitcoin, or other blockchains. Smart contracts can be built around these blockchain or DFS nodes to ensure safety and concurrency checks, and each system will be able to act pseudo-anonymously and independently—effective ‘co-owning’ an asset. This can be used in multi-party trustless custody, or extended ‘edge node in the field’ scenarios.

Thus, the examples herein provide a set of nodes with access to a blockchain arrangement. A first node is configured to obtain a current plan from the blockchain relating to operations of at least a satellite in orbit, make changes to the current plan to create an updated plan, and attempt to add the updated plan into the blockchain. Responsive to the updated plan, one or more nodes (which could be the first node or other nodes) of the blockchain are configured to perform one or more feasibility checks for the updated plan, and responsive to passing of the feasibility checks, publish the updated plan into the plan on the blockchain. Once published in the blockchain, the updated plan is executed by an execution node in communication with the satellite.

The functional block diagrams, operational scenarios and sequences, and flow diagrams provided in the Figures are representative of exemplary systems, environments, and methodologies for performing novel aspects of the disclosure. While, for purposes of simplicity of explanation, methods included herein may be in the form of a functional diagram, operational scenario or sequence, or flow diagram, and may be described as a series of acts, it is to be understood and appreciated that the methods are not limited by the order of acts, as some acts may, in accordance therewith, occur in a different order and/or concurrently with other acts from that shown and described herein. For example, those skilled in the art will understand and appreciate that a method could alternatively be represented as a series of interrelated states or events, such as in a state diagram. Moreover, not all acts illustrated in a methodology may be required for a novel implementation.

The descriptions and figures included herein depict specific implementations to teach those skilled in the art how to make and use the best options. For the purpose of teaching inventive principles, some conventional aspects have been simplified or omitted. Those skilled in the art will appreciate variations from these implementations that fall within the scope of this disclosure. Those skilled in the art will also appreciate that the features described above can be combined in various ways to form multiple implementations.

What is claimed is:

1. An apparatus, comprising:
a node having access to a blockchain, and configured to:
obtain an operational plan relating to logistical operations of one or more devices;
perform a feasibility check for the operational plan based on logical rules implemented by the blockchain to determine a feasibility of an implementation of the logistical operations via the one or more devices; and
in response to satisfying the feasibility check, publish the plan to the blockchain.

2. The apparatus of claim 1, wherein the node has access to a distributed data store, and wherein to obtain the operational plan, the node is configured to:
obtain the operational plan from the distributed data store; and
obtain an identifier for the operational plan from the distributed data store.

3. The apparatus of claim 2, wherein to obtain the operational plan, the node is further configured to:
update the operational plan resulting in an updated operational plan;
obtain an updated identifier for the updated operational plan from the distributed data store; and
associate the operational plan with the updated operational plan and the updated identifier in the distributed data store and the blockchain.

4. The apparatus of claim 1, wherein the node is further configured to execute the plan based on the publishing of the plan to the blockchain, wherein the node is in communication with the one or more devices.

5. The apparatus of claim 4, wherein the one or more devices comprise one or more controllable assets.

6. The apparatus of claim 1, wherein the operational plan comprises one or more of a timing of the logistical operations, one or more types of the logistical operations, and one or more targets of the logistical operations.

7. The apparatus of claim 6, wherein the logical rules comprise smart contract features implemented by the blockchain and based on capabilities of the one or more devices with which to evaluate the feasibility of the implementation of the logistical operations, wherein the smart contract features comprise one or more of timing rules, operation type rules, and location rules.

8. The apparatus of claim 7, wherein the capabilities of the one or more devices correspond to achievable logistical operations determined by orbital properties, ephemeris, trajectories, or on-board components.

9. An apparatus, comprising:
one or more computer-readable storage media; and
program instructions stored on the one or more computer-readable storage media executable by a processing device to direct the processing device to at least:
obtain an operational plan relating to logistical operations of one or more devices;
perform a feasibility check for the operational plan based on logical rules implemented by a blockchain to determine a feasibility of an implementation of the logistical operations via the one or more devices; and
in response to satisfying the feasibility check, publish the plan to the blockchain.

10. The apparatus of claim 9, wherein to obtain the operational plan, the program instructions direct the processing device to:
obtain the operational plan from a distributed data store; and
obtain an identifier for the operational plan from the distributed data store.

11. The apparatus of claim 10, wherein to obtain the operational plan, the program instructions direct the processing device to:
update the operational plan resulting in an updated operational plan;
obtain an updated identifier for the updated operational plan from the distributed data store; and
associate the operational plan with the updated operational plan and the updated identifier in the distributed data store and the blockchain.

12. The apparatus of claim 9, wherein the program instructions further direct the processing device to execute the plan based on the publishing of the plan to the blockchain.

13. The apparatus of claim 12, wherein the one or more devices comprise one or more controllable assets.

14. The apparatus of claim 9, wherein the operational plan comprises one or more of a timing of the logistical operations, one or more types of the logistical operations, and one or more targets of the logistical operations.

15. The apparatus of claim 14, wherein:
the logical rules comprise smart contract features implemented by the blockchain and based on capabilities of the one or more devices with which to evaluate the feasibility of the implementation of the logistical operations;
the smart contract features comprise one or more of timing rules, operation type rules, and location rules; and
the capabilities of the one or more devices correspond to achievable logistical operations determined by orbital properties, ephemeris, trajectories, or on-board components.

16. A method of operating a node capable of accessing a blockchain, comprising:
obtaining, by the node, an operational plan relating to logistical operations of one or more devices;
performing, by the node, a feasibility check for the operational plan based on logical rules implemented by the blockchain to determine a feasibility of an implementation of the logistical operations via the one or more devices; and
in response to satisfying the feasibility check, publishing, by the node, the plan to the blockchain.

17. The method of claim 16, wherein the node is further capable of accessing to a distributed data store, and wherein obtaining the operational plan comprises:
obtaining, by the node, the operational plan from the distributed data store; and
obtaining, by the node, an identifier for the operational plan from the distributed data store.

18. The method of claim 17, wherein obtaining the operational plan further comprises:
updating, by the node, the operational plan resulting in an updated operational plan;
obtaining, by the node, an updated identifier for the updated operational plan from the distributed data store; and
associating, by the node, the operational plan with the updated operational plan and the updated identifier in the distributed data store and the blockchain.

19. The method of claim 16, further comprising executing, by the node, the plan based on the publishing of the plan to the blockchain, wherein the node is in communication with the one or more devices, and wherein the one or more devices comprise one or more controllable assets.

20. The method of claim 16, wherein:
the operational plan comprises one or more of a timing of the logistical operations, one or more types of the logistical operations, and one or more targets of the logistical operations;
the logical rules comprise smart contract features corresponding to one or more of timing rules, operation type rules, and location rules implemented by the blockchain and based on capabilities of the one or more devices with which to evaluate the feasibility of the implementation of the logistical operations; and
the capabilities correspond to achievable logistical operations determined by orbital properties, ephemeris, trajectories, or on-board components.
